(19) United States
(12) Patent Application Publication
(10) Pub. No.: US 2022/0252007 A1
(43) Pub. Date: Aug. 11, 2022

(54) ACTIVE COMPRESSOR STALL RECOVERY

(71) Applicant: General Electric Company, Schenectady, NY (US)

(72) Inventors: David Alexander Hiett, Cincinnati, OH (US); David Marion Ostdiek, Liberty Township, OH (US); Stefan Joseph Cafaro, Chapel Hill, NC (US); Robert Jon McQuiston, Cincinnati, OH (US)

(21) Appl. No.: 17/170,245

(22) Filed: Feb. 8, 2021

(51) Int. Cl. F02C 6/20; F02C 9/00; B64D 31/06; B64D 27/24

(52) U.S. Cl. CPC F02C 6/20; F02C 6/206; F02C 9/00; B64D 31/06; F05D 2270/303; F05D 2220/323; F05D 2270/101; F05D 2270/62; F05D 2270/301; B64D 27/24

(57) ABSTRACT

A method for operating a hybrid-electric propulsion system of an aircraft, the hybrid-electric propulsion system, the method comprising: sensing data indicative of at least one of an aerodynamic instability, a pressure, or a temperature within the HP compressor and the LP compressor of the gas turbine engine; identifying a aerodynamically unstable compressor by determining that conditions within one of the HP compressor or the LP compressor are within a threshold of a stall condition based at least in part on the sensed data within the HP compressor and the LP compressor of the gas turbine engine, the one of the HP compressor or the LP compressor that is determined to be within the threshold of a stall condition being the aerodynamically unstable compressor; and transferring power, via the one or more electric machines, to the aerodynamically unstable compressor in order to clear the stall condition.

### FIELD

The present subject matter relates generally to hybrid-electric power systems for aircraft and aircraft engines, and methods for operating the same to recover from a compressor stall condition.

### BACKGROUND

Compression systems, such as rotating compressors and pumps, may be subject to certain flow instabilities during operation, including rotating stall and surge. Generally, surge is caused by oscillations or rapid pulsations of mass flow and pressure through the compression system, and rotating stall is caused by locally reduced or blocked flow within the compression system. Both surge and rotating stall are undesirable. Particularly, surge may damage components of the compression system as well as other components positioned upstream and/or downstream of the compression system. Rotating stall results in inefficient operation of the compression system. Rotating stall and surge have other drawbacks as well.

Many compression systems, such as axial and centrifugal compressors for turbine engines, have an associated compressor map that describes the compressor's characteristics. For instance, compressor maps typically include a surge line that demarcates a stable operating region from an unstable operating region for various characteristic curves, e.g., speed settings of the turbine engine. If the pressure ratio increases above a stability line or decreases below the stability line, or more particularly to the left of the stability line, an aerodynamic instability results. On the other hand, if the mass flow through the compressor is below the stability line, or more particularly to the right of the stability line, the compression system is operating at a stable operating point or range.

Conventionally, to prevent surge, a surge margin or surge control line is drawn at a distance from the surge line and surge avoidance controls of the compression system ensure that the operating point of the compression system does not cross the surge control line. That is, the surge avoidance controls ensure that the operating point is at or right of the stability control line. However, such surge avoidance schemes restrict the operating range of the compression system and thus limit efficiency.

Other techniques for accounting for surge and rotating stall in addition or alternatively to surge avoidance controls include active surge control schemes that seek to stabilize surge and rotating stall rather than avoiding them. For instance, compressors may include various variable geometry components that may be actuated to control surge and rotating stall. For example, recycle, bleed, and throttle valves, variable guide vanes, etc. have been utilized for active surge control. While such active surge components are generally effective in controlling surge and rotating stall, they add extra weight, require additional components, and in many instances impart a penalty on the efficiency of the compression system.

Thus, a compression system and methods of operating the same that provide for active stall recovery, rather than stall avoidance, would be advantageous in the art.

### BRIEF DESCRIPTION

Aspects and advantages of the invention will be set forth in part in the following description, or may be obvious from the description, or may be learned through practice of the invention.

In one exemplary aspect of the present disclosure, a method for operating a hybrid-electric propulsion system of an aircraft is provided. The hybrid-electric propulsion system includes a gas turbine engine having a high pressure (“HP”) compressor, a low pressure (“LP”) compressor, and one or more electric machines coupled to at least one of the HP compressor and the low pressure compressor. The method includes a step of sensing data indicative of at least one of an aerodynamic instability, a pressure, or a temperature within the HP compressor and the LP compressor of the gas turbine engine. The method further includes a step of identifying an aerodynamically unstable compressor by determining that conditions within one of the HP compressor or the LP compressor are within a threshold of a stall condition based at least in part on the sensed data within the HP compressor and the LP compressor of the gas turbine engine. The one of the HP compressor or the LP compressor that is determined to be within the threshold of a stall condition being the aerodynamically unstable compressor. The method further includes transferring power, via the one or more electric machines, to the aerodynamically unstable compressor in order to clear the stall condition.

These and other features, aspects, and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures, in which:

FIG. 1 is a schematic, cross-sectional view of a gas turbine engine in accordance with an exemplary embodiment of the present disclosure.

FIG. 2 is a schematic, cross-sectional view of a gas turbine engine in accordance with another exemplary embodiment of the present disclosure.

FIG. 3 is a schematic, cross-sectional view of a compressor of a gas turbine engine in accordance with an exemplary aspect of the present disclosure.

FIG. 4 is a schematic view of a stage of a compressor of a gas turbine engine in accordance with an exemplary aspect of the present disclosure.

FIG. 5 is a control logic diagram capable of being executed by one or more controllers in communication with a gas turbine engine in accordance with an exemplary aspect of the present disclosure.

FIG. 6 is a pressure vs time plot of an actively accelerating or decelerating hybrid-electric propulsion system, on which pressure data from sensors positioned within a compressor are plotted against time in accordance with an exemplary aspect of the present disclosure.

FIG. 7 is a temperature vs time plot of an actively accelerating or decelerating hybrid-electric propulsion system, on which temperature data from sensors positioned within a compressor are plotted against time in accordance with an exemplary aspect of the present disclosure.

FIG. 8 illustrates a pressure vs flow plot of an actively accelerating or decelerating hybrid-electric propulsion system, on which pressure data from sensors positioned within a compressor are plotted against the flow through the core air flowpath of the compressor in accordance with an exemplary aspect of the present disclosure.

FIG. 9 is a flow diagram of a method for operating a hybrid-electric propulsion system of an aircraft in accordance with an exemplary aspect of the present disclosure.

### DETAILED DESCRIPTION

Reference will now be made in detail to present embodiments of the invention, one or more examples of which are illustrated in the accompanying drawings. The detailed description uses numerical and letter designations to refer to features in the drawings. Like or similar designations in the drawings and description have been used to refer to like or similar parts of the invention.

The word “exemplary” is used herein to mean “serving as an example, instance, or illustration.” Any implementation described herein as “exemplary” is not necessarily to be construed as preferred or advantageous over other implementations. Additionally, unless specifically identified otherwise, all embodiments described herein should be considered exemplary.

As used herein, the terms “first”, “second”, and “third” may be used interchangeably to distinguish one component from another and are not intended to signify location or importance of the individual components.

The terms “forward” and “aft” refer to relative positions within a gas turbine engine or vehicle, and refer to the normal operational attitude of the gas turbine engine or vehicle. For example, with regard to a gas turbine engine, forward refers to a position closer to an engine inlet and aft refers to a position closer to an engine nozzle or exhaust.

The terms “upstream” and “downstream” refer to the relative direction with respect to a flow in a pathway. For example, with respect to a fluid flow, “upstream” refers to the direction from which the fluid flows, and “downstream” refers to the direction to which the fluid flows. However, the terms “upstream” and “downstream” as used herein may also refer to a flow of electricity.

The singular forms “a”, “an”, and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about”, “approximately”, “generally”, and “substantially”, are not to be limited to the precise value specified. In at least some instances, the approximating language may correspond to the precision of an instrument for measuring the value, or the precision of the methods or machines for constructing or manufacturing the components and/or systems. In at least some instances, the approximating language may correspond to the precision of an instrument for measuring the value, or the precision of the methods or machines for constructing or manufacturing the components and/or systems. For example, the approximating language may refer to being within a 1, 2, 4, 5, 10, 15, or 20 percent margin in either individual values, range(s) of values and/or endpoints defining range(s) of values.

Here and throughout the specification and claims, range limitations are combined and interchanged, such ranges are identified and include all the sub-ranges contained therein unless context or language indicates otherwise. For example, all ranges disclosed herein are inclusive of the endpoints, and the endpoints are independently combinable with each other.

In aeronautical gas turbine engines, the compressors are generally designed to operate within a conservative predetermined threshold of a compressor stall margin so as to reduce a risk of compressor stall under even the most harsh operating conditions, and assuming the engine has experience an expected amount of degradation (e.g., wearing out of seal, minor damage, etc.). Such may lead to the compressor, and engine as a whole, not being operated at or near its full potential.

With a hybrid electric aeronautical gas turbine engine, an electric machine may be coupled to one or both of the compressors, such as to a shaft rotatable with the compressor(s). The present disclosure utilizes the electric machine to facilitate recovery of the compressor(s) once they have entered a stalled-state or are undergoing stalled conditions. More specifically, the present disclosure utilizes one or more sensors within the compressor section to sense data indicative of a stall condition within the compressor, indicative of being within a threshold of a stall condition within the compressor, and/or indicative of being within the threshold of a stall margin. In response, power/torque may be added to the compressor with the electric machine to allow the compressor(s) to exit the aerodynamically unstable or stalled condition and continue operating under normal conditions.

In certain conditions, data may be sensed indicative that one of the compressors is experiencing an aerodynamic instability (such as a rotating instability, rotating stall, or a surge stall) using sensors (e.g. high frequency sensors, temperature or pressure sensors, low frequency temperature or pressure sensors, optical sensors, or other suitable sensors). The electric machine may then transfer power from a separate compressor (which is aerodynamically stable) or from an energy storage unit to the aerodynamically instable compressor, in order to exit rotating stall condition and allow continued operation of the compressor at the desired levels without experiencing compressor rotating stall. As used herein the term “aerodynamically unstable” compressor may refer to a compressor that is experiencing an aerodynamic instability, such as a rotating instability, rotating stall, surge stall. As a result, the aerodynamically unstable compressor may be experiencing an aeromechanical response (e.g. flutter).

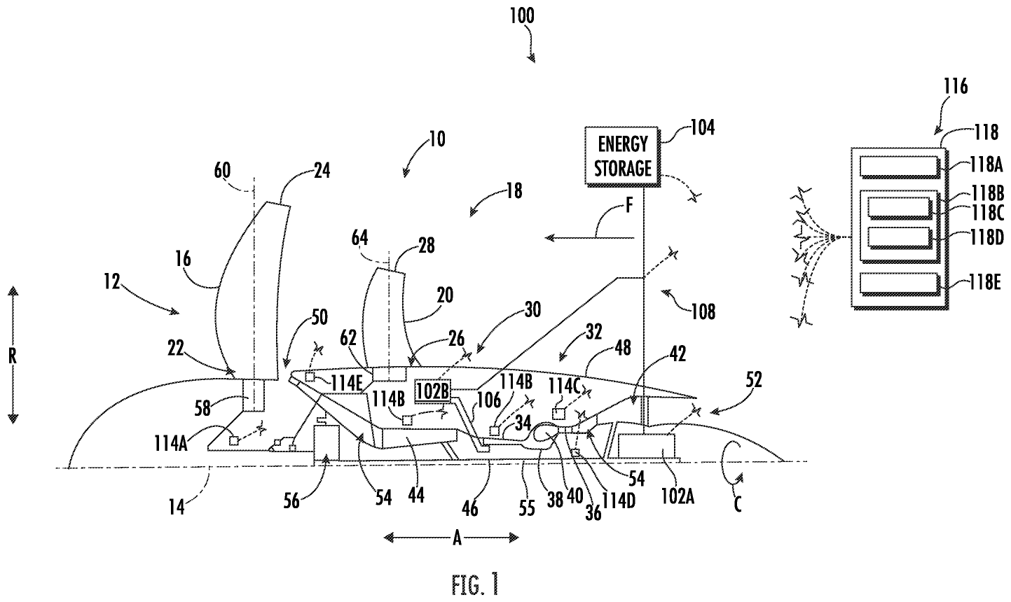

Referring now to FIG. 1, a cross-sectional view of an exemplary embodiment of a gas turbine engine as may incorporate one or more inventive aspects of the present disclosure is provided. In particular, the exemplary gas turbine engine of FIG. 1 is a configured as a single unducted rotor engine 10 defining an axial direction A, a radial direction R, and a circumferential direction C. As is seen from FIG. 1, the engine 10 takes the form of an open rotor propulsion system and has a rotor assembly 12 which includes an array of airfoils arranged around a central longitudinal axis 14 of engine 10, and more particularly includes an array of rotor blades 16 arranged around the central longitudinal axis 14 of engine 10.

Moreover, as will be explained in more detail below, the engine 10 additionally includes a non-rotating vane assembly 18 positioned aft of the rotor assembly 12 (i.e., non-rotating with respect to the central axis 14), which includes an array of airfoils also disposed around central axis 14, and more particularly includes an array of vanes 20 disposed around central axis 14.

The rotor blades 16 are arranged in typically equally spaced relation around the centerline 14, and each blade has a root 22 and a tip 24 and a span defined therebetween. Similarly, the vanes 20 are also arranged in typically equally spaced relation around the centerline 14, and each has a root 26 and a tip 28 and a span defined therebetween. The rotor assembly 12 further includes a hub 44 located forward of the plurality of rotor blades 16.

Additionally, the engine 10 includes a turbomachine 30 having a core (or high pressure/high speed system) 32 and a low pressure/low speed system. It will be appreciated that as used herein, the terms “speed” and “pressure” are used with respect to the high pressure/high speed system and low pressure/low speed system interchangeably. Further, it will be appreciated that the terms “high” and “low” are used in this same context to distinguish the two systems, and are not meant to imply any absolute speed and/or pressure values.

The core 32 generally includes a high-speed compressor 34, a high speed turbine 36, and a high speed shaft 38 extending therebetween and connecting the high speed compressor 34 and high speed turbine 36. The high speed compressor 34, the high speed turbine 36, and the high speed shaft 38 may collectively be referred to as a high speed spool of the engine. Further, a combustion section 40 is located between the high speed compressor 34 and high speed turbine 36. The combustion section 40 may include one or more configurations for receiving a mixture of fuel and air, and providing a flow of combustion gasses through the high speed turbine 36 for driving the high speed spool.

The low speed system similarly includes a low speed turbine 42, a low speed or low pressure compressor or booster, 44, and a low speed shaft 46 extending between and connecting the low speed compressor 44 and low speed turbine 42. The low speed compressor 44, the low speed turbine 42, and the low speed shaft 46 may collectively be referred to as a low speed spool 55 of the engine.

Although the engine 10 is depicted with the low speed compressor 44 positioned forward of the high speed compressor 34, in certain embodiments the compressors 34, 44 may be in an interdigitated arrangement. Additionally, or alternatively, although the engine 10 is depicted with the high speed turbine 36 positioned forward of the low speed turbine 42, in certain embodiments the turbines 36, 42 may similarly be in an interdigitated arrangement.

Referring still to FIG. 1, the turbomachine 30 is generally encased in a cowl 48. Moreover, it will be appreciated that the cowl 48 defines at least in part an inlet 50 and an exhaust 52, and includes a turbomachinery flowpath 54 extending between the inlet 50 and the exhaust 52. The inlet 50 is for the embodiment shown an annular or axisymmetric 360 degree inlet 50 located between the rotor blade assembly 12 and the fixed or stationary vane assembly 18, and provides a path for incoming atmospheric air to enter the turbomachinery flowpath 54 (and compressors 44, 34, combustion section 40, and turbines 36, 42) inwardly of the guide vanes 28 along the radial direction R. Such a location may be advantageous for a variety of reasons, including management of icing performance as well as protecting the inlet 50 from various objects and materials as may be encountered in operation.

However, in other embodiments, the inlet 50 may be positioned at any other suitable location, e.g., aft of the vane assembly 18, arranged in a non-axisymmetric manner, etc.

As is depicted, the rotor assembly 12 is driven by the turbomachine 30, and more specifically, is driven by the low speed spool 55. More specifically, still, engine 10 in the embodiment shown in FIG. 1 includes a power gearbox 56, and the rotor assembly 12 is driven by the low speed spool 55 of the turbomachine 30 across the power gearbox 56. In such a manner, the rotating rotor blades 16 of the rotor assembly 12 may rotate around the axis 14 and generate thrust to propel engine 10, and hence an aircraft to which it is associated, in a forward direction F.

The power gearbox 56 may include a gearset for decreasing a rotational speed of the low speed spool 55 relative to the low speed turbine 42, such that the rotor assembly 12 may rotate at a slower rotational speed than the low speed spool 55.

As briefly mentioned above the engine 10 includes a vane assembly 18. The vane assembly 18 extends from the cowl 48 and is positioned aft of the rotor assembly 12. The vanes 20 of the vane assembly 18 may be mounted to a stationary frame or other mounting structure and do not rotate relative to the central axis 14. For reference purposes, FIG. 1 also depicts the forward direction with arrow F, which in turn defines the forward and aft portions of the system. As shown in FIG. 1, the rotor assembly 12 is located forward of the turbomachine 30 in a “puller” configuration, and the exhaust 52 is located aft of the guide vanes 28. As will be appreciated, the vanes 20 of the vane assembly 18 may be configured for straightening out an airflow (e.g., reducing a swirl in the airflow) from the rotor assembly 12 to increase an efficiency of the engine 10. For example, the vanes 20 may be sized, shaped, and configured to impart a counteracting swirl to the airflow from the rotor blades 16 so that in a downstream direction aft of both rows of airfoils (e.g., blades 16, vanes 20) the airflow has a greatly reduced degree of swirl, which may translate to an increased level of induced efficiency.

Referring still to FIG. 1, it may be desirable that the rotor blades 16, the vanes 20, or both, incorporate a pitch change mechanism such that the airfoils (e.g., blades 16, vanes 20, etc.) can be rotated with respect to an axis of pitch rotation either independently or in conjunction with one another. Such pitch change can be utilized to vary thrust and/or swirl effects under various operating conditions, including to adjust a magnitude or direction of thrust produced at the rotor blades 16, or to provide a thrust reversing feature which may be useful in certain operating conditions such as upon landing an aircraft, or to desirably adjust acoustic noise produced at least in part by the rotor blades 16, the vanes 20, or aerodynamic interactions from the rotor blades 16 relative to the vanes 20. More specifically, for the embodiment of FIG. 1, the rotor assembly 12 is depicted with a pitch change mechanism 58 for rotating the rotor blades 16 about their respective pitch axes 60, and the vane assembly 18 is depicted with a pitch change mechanism 62 for rotating the vanes 20 about their respective pitch axes 64.

It will be appreciated, however, that the exemplary single rotor unducted engine 10 depicted in FIG. 1 is by way of example only, and that in other exemplary embodiments, the engine 10 may have any other suitable configuration, including, for example, any other suitable number of shafts or spools, turbines, compressors, etc.; fixed-pitch blades 16, 20, or both; a direct-drive configuration (i.e., may not include the gearbox 56); etc. For example, in other exemplary embodiments, the engine 10 may be a three-spool engine, having an intermediate speed compressor and/or turbine. In such a configuration, it will be appreciated that the terms “high” and “low,” as used herein with respect to the speed and/or pressure of a turbine, compressor, or spool are terms of convenience to differentiate between the components, but do not require any specific relative speeds and/or pressures, and are not exclusive of additional compressors, turbines, and/or spools or shafts.

Additionally, or alternatively, in other exemplary embodiments, any other suitable gas turbine engine may be provided. For example, in other exemplary embodiments, the gas turbine engine may be a turboshaft engine, a turboprop engine, turbojet engine, etc. Moreover, for example, although the engine is depicted as a single unducted rotor engine, in other embodiments, the engine may include a multi-stage open rotor configuration, and aspects of the disclosure described hereinbelow may be incorporated therein.

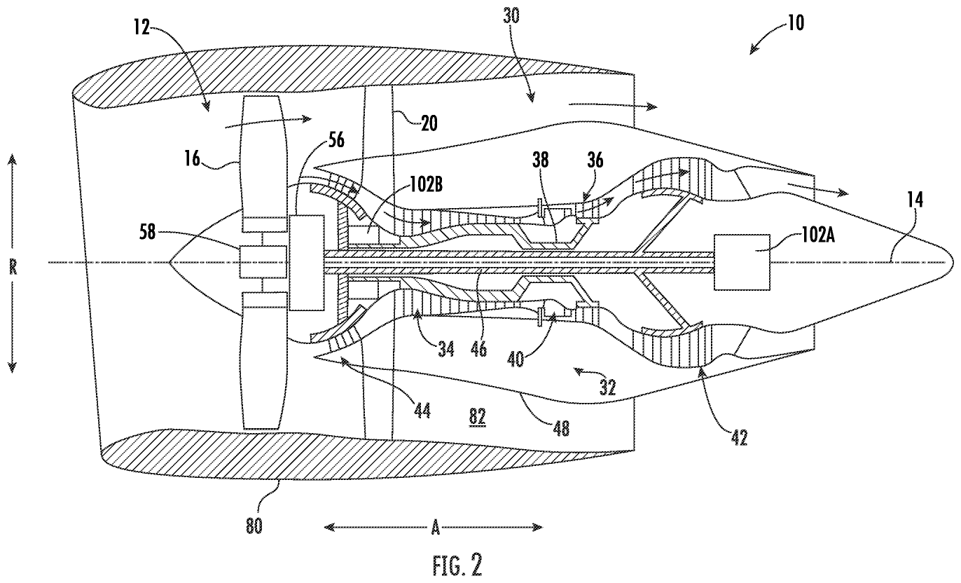

Further, still, in other exemplary embodiments, the engine 10 may be configured as a ducted turbofan engine. For example, referring briefly to FIG. 2, an engine 10 in accordance with another exemplary embodiment of the present disclosure is depicted. The exemplary embodiment of FIG. 2 may be configured in substantially the same manner as the exemplary engine 10 described above with respect to FIG. 1, and the same or similar reference numerals may refer to the same or similar parts. However, as will be appreciated, for the embodiment shown, the engine 10 further includes a nacelle 80 circumferentially surrounding at least in part the rotor assembly 12 and turbomachine 30, defining a bypass passage 82 therebetween.

Referring now back to FIG. 1, it will be appreciated that the engine is integrated with an electric power system 100. The electric power system 100 generally includes an electric machine 102 coupled to at least one of the high pressure system (or core 32) or the low pressure system, and an energy storage unit 104

Further, for the embodiment shown, the electric machine 102 of the electric power system 100 is an LP electric machine 102A coupled to the low pressure system of the engine. More specifically, for the embodiment shown, the LP electric machine 102A is embedded within the engine 10, at a location within or aft of the turbine section of the engine 10, and inward of the core airflow path 54 through the engine 10 along the radial direction R. It will be appreciated, however, that in other example embodiments, the LP electric machine 102A may additionally, or alternatively, be configured in the other suitable manner. For example, in other embodiments, the LP electric machine 102A may be embedded within a compressor section of the engine 10, may be located outward of core airflow path 54 along the radial direction R (and, e.g., within the cowl 48), etc.

Moreover, for the embodiment shown, the LP electric machine 102A is not the only electric machine 102 of the electric power system 100 integrated with the engine 10. More specifically, the electric power system 100 further includes an HP electric machine 102B coupled to the high-pressure system/core of the engine 10, and in electrical communication with the electric power bus 108. The HP electric machine 102B is, for the embodiment shown, also embedded within the engine 10 at a location inward of the core airflow path 54. However, for the embodiment shown, the HP electric machine 102B is located within the compressor section of the engine 10. It will be appreciated that in other embodiments, the HP electric machine 102B may alternatively be positioned outward of the core airflow path 54 along the radial direction R, driven through, e.g., a geared connection. For example, in certain embodiments, the HP electric machine 102B may be coupled to an accessory gearbox (not shown), which is in turn coupled to the high-pressure system of the engine 10. In many embodiments, the HP electric machine 102B may be coupled to the high speed shaft 38 (e.g. directly coupled to the high speed shaft 38 in some embodiments). In other embodiments, the HP electric machine 102B may be coupled to the high speed shaft 38 via one or more intermediate shafts 106 extending between the HP electric machine and the high speed shaft 38.

In at least certain exemplary embodiments, the energy storage unit 104 may include one or more batteries. Additionally, or alternatively, the energy storage unit 104 may include one or more supercapacitor arrays, one or more ultracapacitor arrays, or both. In at least certain embodiments, the energy storage unit 104 may be configured to provide at least 5 kilowatts (kW) of energy to the electric power system 100, such as at least 50 kW, such as at least 50 kW, such as at least 250 kW, such as at least 300 kW, such as at least 350 kW, such as at least 400 kW, such as at least 500 kW, such as up to 5 megawatts (MW), such as up to 10 megawatts (MW). Further, the energy storage unit 104 may be configured to provide such electrical power for at least two minutes, such as at least three minutes, such as at least five minutes, such as up to an hour. Further, still, in other embodiments, the energy storage unit 104 may be configured to provide such electrical power for any other suitable duration.

Moreover, for the embodiment shown, the electric power system 100 includes an electric power bus 108 electrically connecting the various components of electric power system 100. The electric power bus 108 may be, e.g., one or more electrical lines arranged in any suitable configuration.

Referring still to the exemplary embodiment of FIG. 1, although not depicted, it will be appreciated that the exemplary electric power system may also include an auxiliary power unit. The auxiliary power unit, if included, may include a combustion engine driving an electric generator, and may be located remotely from the engine 10. For example, in at least certain exemplary embodiments, the auxiliary power unit, if provided, may be located within a fuselage of the aircraft utilizing the engine 10, e.g., at an aft end of the aircraft, and electrically coupled to the electric power bus 108.

Referring still to FIG. 1, the exemplary electric power system 100 is operably connected to a controller 116. The controller 116 may be an engine controller for the engine 10 (e.g., a Full Authority Digital Engine Control controller), may be an aircraft controller, may be a controller dedicated to the electric power system 100, etc.

The controller 116 may be configured to receive data indicative of various operating conditions and parameters of the engine 10 during operation of the engine 10. For example, the engine 10 includes one or more sensors 114 configured to sense data indicative of various operating conditions and parameters of the engine 10, such as rotational speeds, temperatures, pressures, vibrations, etc. More specifically, however, for the exemplary embodiment depicted in FIG. 1, the one or more sensors 114 includes a first speed sensor 114A configured to sense data indicative of one or more parameters of the rotor assembly 12 (e.g., rotational speed, acceleration, torque on the rotor shaft driving the rotor assembly 12, etc.); a second sensor 114B configured to sense data indicative of the compressors (such as a pressure within the high pressure compressor 34, a pressure within the low pressure compressor 44, etc.); a third sensor 114C configured to sense data indicative of one or combustion section parameters (such as a temperature within the combustion section 40, a fuel flow to the combustion section 40, one or more pressures within or around the combustion section 40, etc.), one or more high pressure turbine parameters (such as turbine inlet temperature, a rotational speed of the high pressure turbine 36, etc.), or both; a fourth sensor 114D operable to sense data indicative of one or more parameters of the low pressure system (such as a rotational speed of the low pressure spool 55); and a fifth sensor 114E configured to sense data indicative of one or more variable geometry components (such as a position of one or more variable inlet guide vanes, outlet guide vanes, rotor blades 16, guide vanes 20, etc.).

In some embodiments, the controller 116 may be operable to receive optical data from one or more optical sensors. For example, the system may include one or more light probes that are configured to monitor the compressor blades for positional movement (such as flutter or other aeromechanical movement indicative of aerodynamically unstable conditions within a compressor). The one or more optical sensors (e.g. light probes) may then communicate the sensed data to the controller 116.

Alternatively or additionally, the controller 116 may be operable to receive feedback or data from one or more actuators coupled to rotor blades within a compressor of the engine, which may be indicative of aerodynamically unstable conditions (such as a rotating stall) within the compressor. For example, the one or more actuators may communicate force fluctuations measured from the rotor blades within the compressor to the controller 116 that is indicative of aerodynamically unstable conditions within the compressor. The force fluctuations may arise from an aeromechanical response (such as flutter) of the rotor blades to the aerodynamically unstable conditions (such as a rotating stall) within the compressor.

Referring particularly to the operation of the controller 116, in at least certain embodiments, the controller 116 can include one or more computing device(s) 118. The computing device(s) 118 can include one or more processor(s) 118A and one or more memory device(s) 118B. The one or more processor(s) 118A can include any suitable processing device, such as a microprocessor, microcontroller, integrated circuit, logic device, and/or other suitable processing device. The one or more memory device(s) 118B can include one or more computer-readable media, including, but not limited to, non-transitory computer-readable media, RAM, ROM, hard drives, flash drives, and/or other memory devices.

The one or more memory device(s) 118B can store information accessible by the one or more processor(s) 118A, including computer-readable instructions 118C that can be executed by the one or more processor(s) 118A. The instructions 118C can be any set of instructions that when executed by the one or more processor(s) 118A, cause the one or more processor(s) 118A to perform operations. In some embodiments, the instructions 118C can be executed by the one or more processor(s) 118A to cause the one or more processor(s) 118A to perform operations, such as any of the operations and functions for which the controller 116 and/or the computing device(s) 118 are configured, the operations for operating an electric power system 100 (e.g., method 300), as described herein, and/or any other operations or functions of the one or more computing device(s) 118. The instructions 118C can be software written in any suitable programming language or can be implemented in hardware. Additionally, and/or alternatively, the instructions 118C can be executed in logically and/or virtually separate threads on processor(s) 118A. The memory device(s) 118B can further store data 118D that can be accessed by the processor(s) 118A. For example, the data 118D can include data indicative of power flows, data indicative of engine 10/aircraft operating conditions, and/or any other data and/or information described herein.

The computing device(s) 118 can also include a network interface 118E used to communicate, for example, with the other components of the engine 10, the aircraft incorporating the engine 10, the electric power system 100, etc. For example, in the embodiment depicted, as noted above, the engine 10 includes one or more sensors 114 for sensing data indicative of one or more parameters of the engine 10 and various accessory systems, and the electric power system 100 includes an energy storage unit 104, an LP electric machine 102A, an HP electric machine 102B, and an auxiliary power unit. The controller 116 is operably coupled to these components through, e.g., the network interface 118E, such that the controller 116 may receive data indicative of various operating parameters sensed by the one or more sensors 114 during operation, various operating conditions of the components, etc., and further may provide commands to control electrical flow of the electric power system 100 and other operating parameters of these systems, e.g., in response to the data sensed by the one or more sensors 114 and other conditions.

The network interface 118E can include any suitable components for interfacing with one or more network(s), including for example, transmitters, receivers, ports, controllers, antennas, and/or other suitable components. For example, in the embodiment shown, the network interface 118E is configured as a wireless communication network wirelessly in communication with these components (as is indicated by the dashed communication lines in FIG. 1).

The technology discussed herein makes reference to computer-based systems and actions taken by and information sent to and from computer-based systems. One of ordinary skill in the art will recognize that the inherent flexibility of computer-based systems allows for a great variety of possible configurations, combinations, and divisions of tasks and functionality between and among components. For instance, processes discussed herein can be implemented using a single computing device or multiple computing devices working in combination. Databases, memory, instructions, and applications can be implemented on a single system or distributed across multiple systems. Distributed components can operate sequentially or in parallel.

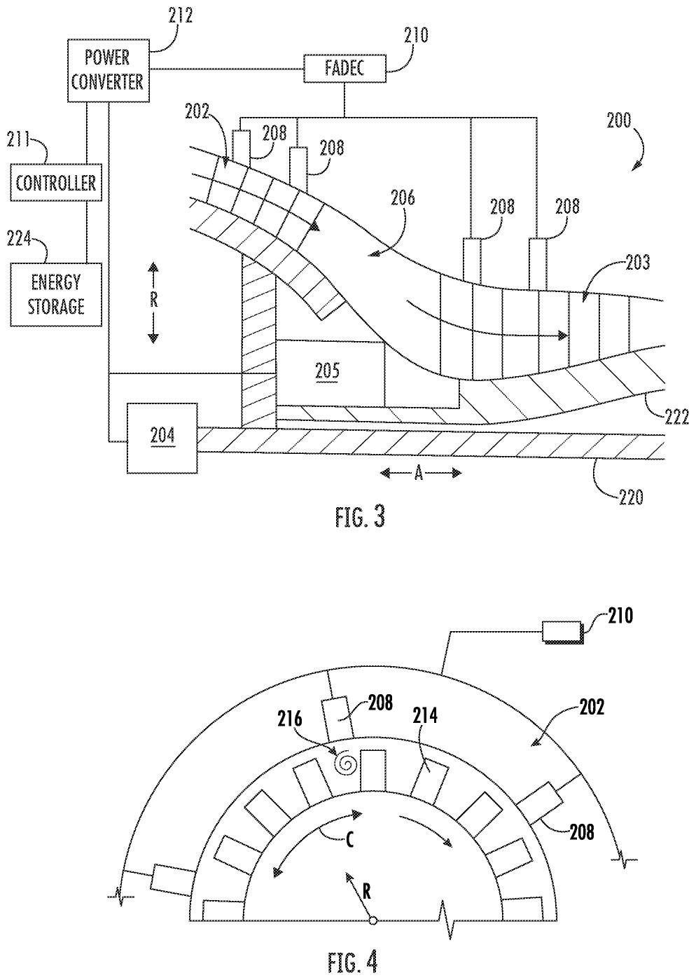

Referring now to FIG. 3, a close-up view of a low pressure (“LP”) compressor 202 and a high pressure (“HP”) compressor 203 of a gas turbine engine 200. As shown in FIG. 3 and described above, the LP compressor may be coupled to a low speed shaft 220, such that the LP compressor 202 rotates along with the low speed shaft 220. Similarly, the HP compressor may be coupled to a high speed shaft 222, such that the HP compressor 203 rotates along with the high speed shaft 222. In exemplary embodiments, the gas turbine 200 may include an LP electric machine 204 coupled to low speed shaft 220 and a HP electric machine 205 coupled to the high speed shaft 222. The LP compressor 202 may be the low pressure compressor 44 and the HP compressor 203 may the high pressure compressor 34, and in such a manner, it will be appreciated that the gas turbine engine 200 may be configured in a similar manner as the exemplary gas turbine engines 10 described above with reference to, e.g., FIGS. 1 and 2.

Notably, however, in other embodiments, the systems and methods of the present disclosure may be applied to a fan, such as a ducted fan, such as the ducted fan depicted in FIG. 2. In these alternative embodiments, the sensors discussed below may be arranged outward of the low pressure compressor rotor blades or the fan blades, respectively.

Referring still to FIG. 3, the gas turbine engine 200 further includes a LP electric machine 204 coupled to the low speed shaft 220, thereby operable to modify the speed of the LP compressor 202 by modifying (e.g. adding or extracting) an amount of rotational power applied to the shaft 220 by the LP electric machine 204. Similarly, the gas turbine engine 200 further includes a HP electric machine 205 coupled to the high speed shaft 222, thereby operable to modify the speed of the HP compressor 203 by modifying (e.g. adding or removing) an amount of rotational power applied to the shaft 222 by the HP electric machine 205.

In various embodiments, the LP electric machine 204 may be configured similarly to the exemplary LP electric machine 102A of FIGS. 1 and 2, and the HP electric machine 205 may be configured similarly to the exemplary HP electric machine 102B of FIGS. 1 and 2. Alternatively, however, the electric machines 204 and 205 may be configured in any other suitable manner. For example, for the embodiment shown, the electric machines 204, 205 are embedded within the engine 200 (e.g., positioned inward of a core air flowpath 206 along a radial direction R). However, in other embodiments, one or both of the electric machines 204, 205 may be coupled to the respective compressors 202, 203 through an offset connection (e.g., through a gear train extending through the core air flowpath 206; see FIG. 1). The electric machines 204, 205 may be configured to add power to the respective compressors 202, 203 by way of a shaft rotatable with the compressor 202 and/or extract power from the respective compressors 202, 203 through the shaft rotatable with the compressor 202.

For the embodiment shown, the compressors 202, 203 further include a plurality of sensors 208 configured to sense data at a high frequency that is indicative of a of pressure and/or a temperature within one or both of the compressors 202, 203 and more specifically at one or more locations within the compressors 202, 203, such as at one or more locations within the core air flowpath 206 of the compressors 202, 203 along an axial direction A of the engine 200.

Additionally, or alternatively, referring now also to FIG. 4, providing a schematic view of a stage of compressor rotor blades 214 a compressor 250 (which may be representative of either or both of the LP compressor 202 and the HP compressor 203) along the axial direction A, it will be appreciated that in certain exemplary embodiments, the plurality of sensors 208 may be configured to sense data at a plurality of locations within the core air flowpath 206 of the compressor 250 along a circumferential direction C of the engine 200. Further, as will be appreciated, the sensors 208 may be positioned over the blades 214, such as over the tips of the blades, and aligned with the blades along the axial direction A (each within a reference plane defined by the axial and radial directions A, R). In either configuration, the sensors 208 may be operable to sense data indicative of pressure and/or temperature fluctuations caused by blade tip vortices 216 at the compressor element. For example, when the rotor blades 216 are rotated in a first circumferential direction C, the vortices 216 may form behind one or more of the rotor blades 216, causing pressure fluctuations.

The frequency at which the sensor reads the operating characteristic associated with the compressor element (e.g., the pressure and/or temperature fluctuations at the compressor element) can be on the order of two thousand (2,000) times per second, or approximately equal to the update rate of the one or more computing devices 210 (described below). In such a manner, it will be appreciated that, for example, in certain exemplary aspects, the term “high frequency” refers to a frequency of at least 500 hertz, such as at least 1,000 hertz, such as at least 1,500 hertz, and up to 10,000 hertz, such that a sensing loop closure would occur at least every millisecond.

In certain exemplary embodiments, the sensors 208 may be part of a compressor active stability management (CASM) system designed to protect the engine from compressor stall. For instance, CASM system may receive data (such as temperature data, pressure data, or optical data) from sensors 208 and interpret the data in some way to represent impending stall or that one of the compressors 202, 203 has entered a aerodynamically unstable state (such as a rotating stall). In other embodiments, the sensors 208 may be one or more sensors separate from the CASM system (such as a low frequency sensor). For example, the sensors 208 may be any one of the sensors 114A-E described hereinabove.

Referring back specifically to FIG. 3, the sensors 208 are further configured to transmit such information to an engine controller 210 (such as a FADEC, which may be separate or the same as the controller 116 described hereinabove). The engine controller 210 may be configured in a similar manner as the controller 116 described above with respect to FIG. 1. In such a manner, it will be appreciated that the controller 210 is in operable communication with the electric machines 204 and 205 and the energy storage 224 such that the engine controller 210 can provide instructions configured to modulate a power being extracted from the compressors 202, 203 by utilizing the electric machines 204, 205 and/or a power being added to the compressors 202, 203 by utilizing the electric machines 204, 205 or the energy storage 224. Alternatively or additionally, the engine controller 210 may be in operable communication with an energy storage controller 211, such that the engine controller can identify that one of the compressors 202, 203 is actively stalling (or otherwise aerodynamically unstable) and communicate a request to the energy storage controller 211 for additional power to be routed to the actively stalling compressor 202, 203.

Notably, for the embodiment shown, the controller 210 is in communication with both the LP electric machine 204 and the HP electric machine 205 through a power converter 112, which may include any suitable power electronics, converters, etc. The system described herein may provide power to the electric machines 204, 205 through the connection with the engine controller 210, or alternatively, the engine controller 210 may instead control operation of the power converter 112, which in turn allow for the engine controller 210 to control operation of the electric machines 204, 205.

In exemplary embodiments, the power converter 212 may be operable to transfer power from one of the compressors 202, 203 to the other of the compressors 202, 203 by utilizing the electric machines 204, 205. For example, if the controller 210 determines based on sensed data from the sensors 208 that one of the compressors 202 or 203 has entered a aerodynamically unstable state (e.g. is within the threshold of a stall condition and is experiencing a rotating stall), then the electric machine coupled to the non-stalling compressor may remove power from the non-stalling compressor and transfer that power to the power converter 212, which may be subsequently transferred to the electric machine coupled to the aerodynamically unstable compressor in order escape the stalling conditions.

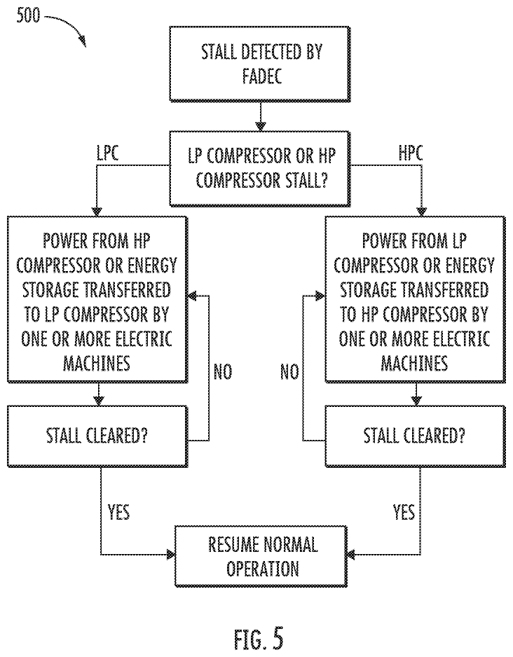

For instance, as shown in FIG. 5, in a non-limiting example, one of the sensors 208 may measure a sudden temperature rise or a sudden pressure drop within (for the purposes of this example) the LP compressor 202. In such an example, the controller 210 may receive the sensed data from the sensors 208 and determine that the LP compressor 202 has entered stalling conditions or is in an aerodynamically unstable state, and in response, may initiate a power share between the LP compressor 202 and the HP compressor 203 to aid the LP compressor 202 in exiting the aerodynamically unstable state. More particularly, the electric machine coupled HP compressor 203 (which is the non-stalling compressor in this example) may begin to remove power from the HP compressor 203 and add that power to the LP compressor 202 (which is the aerodynamically unstable compressor in this example) in order to exit the aerodynamically unstable state. Although, for the purposes of this example, the LP compressor 202 is described as being in an aerodynamically unstable state, it should be understood that the HP compressor may also enter an aerodynamically unstable and receive power from the aerodynamically stable LP compressor 202 in some instances.

In some embodiments, the power may be transferred continuously, using the electric machines 204, 205, at a set rate from the non-stalling compressor (one of the compressors 202 or 203) to the aerodynamically unstable compressor (the other of the compressors 202 or 203) until the stall condition in the aerodynamically unstable compressor is cleared (i.e., until it is determined that conditions within the aerodynamically unstable compressor are no longer within a threshold of a stall condition). For example, in one non-limiting embodiment, the power may be transferred from the non-stalling compressor to the stall state compressor in a continuous linear ramping fashion from about 0 horsepower to about 1200 horsepower (which may represent approximately 0%-25% of the engines total horsepower).

In other embodiments, the power may be transferred incrementally at a set interval of time, using the electric machines 204, 205, from the non-stalling compressor (one of the compressors 202 or 203) to the aerodynamically unstable compressor (the other of the compressors 202 or 203) until the stall condition in the aerodynamically unstable compressor is cleared. For example, the power may be transferred from the non-stalling compressor to the aerodynamically unstable compressor in increments of between about 50 horsepower and about 150 horsepower. In other embodiments, the power may be transferred from the non-stalling compressor to the aerodynamically unstable compressor in increments of between about 75 horsepower and about 125 horsepower.

In such embodiments, in which the power is transferred between the compressors 202, 203 incrementally, once the system has determined that one of the compressors 202, 203 has entered a aerodynamically unstable, the system may begin by transferring a first increment of power (e.g. extracting an increment power from one of the compressors 202 or 203 that is an aerodynamically stable state and adding that increment of power to the other of the compressors 202 or 203 that is in an aerodynamically unstable state). At which point, the system may check if the aerodynamically unstable compressor is still within stalling conditions by monitoring the sensor data received by controller 210 from the one or more sensors 208. If it is determined that, after transferring the first increment of power from the non-stalling compressor to the aerodynamically unstable compressor, the aerodynamically unstable compressor is still within the stall conditions, the system may transfer a second increment of power from the non-stalling compressor to the aerodynamically unstable compressor. This process may be repeated until the stall condition is cleared. That is, once the compressor 202 or 203 that has been identified as being in an aerodynamically unstable condition or state has exited the unstable conditions, the power transfer between the compressors 202 and 203 may be terminated and the engine may resume normal under normal conditions.

In other embodiments, when one of the compressors 202, 203 enters an aerodynamically unstable, power may not need to be transferred (i.e. removed) from the non-stalling compressor. For example, rather than transferring power from the non-stalling compressor to the aerodynamically unstable compressor, the engine controller 210 may opt to supply the aerodynamically unstable compressor with power from an energy storage 224 (which may be the energy storage 104 described herein in some embodiments), thereby not requiring power to be removed from the non-stalling compressor in every instance.

In such a manner, the system described herein may be operable to identify when one of the compressors 202 or 203 has entered an aerodynamically unstable and may be capable of recovering the aerodynamically unstable compressor from stalling conditions by transferring power from a non-stalling compressor on the same engine. More specifically, using sensed data (which may be high frequency sensor data or low frequency sensor data) indicative of a one of a pressure or a temperature within the compressors 202, 203 at the specific locations within the compressors 202, 203, the system may determine if one of the compressors 202, 203 has entered an aerodynamically unstable condition (e.g. entered the threshold of a stall condition and is actively in a rotational stall), such as a rotating stall threshold. As will be appreciated, the term “rotating stall” generally refers to a local disruption of airflow within a compressor which continues to provide compressed air, but with reduced effectiveness. Rotating stall may arise when a small proportion of airfoils experience airfoil stall, disrupting the local airflow without destabilizing the compressor. The stalled airfoils may create pockets of relatively stagnant air which, rather than moving in the flow direction, rotate in a circumferential direction C of the compressor. In certain exemplary embodiments, there may only be one “stalled” airfoil, but the rotating stall may grow from there, propagating to a plurality of airfoils, creating a surge of stalled airfoils and a more pronounced compressor stall.

In order to combat a compressor experiencing rotating stall (or exit the aerodynamically unstable conditions), the system may transfer power (e.g., in the form of a torque on a shaft 106 or spool drivingly coupled to the aerodynamically unstable compressor) from a non-stalling compressor or from an energy storage 224 until the rotating stall has been cleared and the aerodynamically unstable compressor returns to normal operation. For example, in response to sensing data indicative of conditions within a predetermined range of a compressor rotating stall, the system may remove power from a non-stalling compressor using the electric machine (either 204 or 205 depending on which compressor is stalling) and subsequently add that power to the aerodynamically unstable compressor, thereby allowing the compressors 202, 203 to share power as necessary to exit and/or avoid stalling conditions. For example, in one example, in response to sensing data indicative of conditions within one of the compressors 202, 203 have entered a rotating stall threshold, the system may transfer power using the electric machines 204, 205 from the other of the compressors 202, 203 to the stalling compressor until the stalling conditions are cleared.

The system may continue high frequency sensing of the data indicative of a pressure and/or a temperature within both the compressors 202, 203 at the specific locations within the compressors 202, 203 while transferring power from one of the compressors 202, 203 to the other of the compressors 202, 203 in response to the sensed data. In such a manner, a control of the system may be referred to as a feedback control loop. Further, the amount of power transferred may be proportional to the value of sensed data and how close the sensed data indicates the aerodynamically unstable compressor is to exiting the stall condition.

For example, in certain exemplary aspects, the system may continue high frequency sensing of the data indicative of pressure and/or temperature within the compressors 202, 203 at the same locations (e.g., at the same stage of compressor rotor blades 214) while transferring power between the compressors 202, 203 as necessary.

It will also be appreciated that a rotating stall may present pressure fluctuations defining a sinusoidal pattern. In such a manner, the system may sense data indicative of the pressure fluctuations, including a pattern of the pressure fluctuations, at a location within the aerodynamically unstable compressor 202 or 203 with the sensors 208 and may apply the power transferred the non-stalling compressor 202 or 203 with the electric machine at a frequency and magnitude configured to oppose the pattern of the pressure (e.g., in a sinusoidal pattern 180 degrees out of phase with the pattern of the pressure fluctuations, or more generally varying the phase, frequency and/or magnitude of the torque variation to lower the amplitude of pressure variation using a feedback loop). The pressure may be a pressure above a threshold indicative of a rotating stall.

Moreover, it will be appreciated that although for the embodiment shown a plurality of high frequency sensors are used to sense pressure data and/or temperature data to determine the stall condition (or proximity to the stall condition), in other exemplary aspects, the system may additionally or alternatively use other gas turbine engine parameters, such data from other sensors indicative of a rotational speed of one or more components of the engine (e.g., the compressor), a temperature within the engine (e.g., a compressor exit temperature), a torque on one or more components of the engine (e.g., the compressor), etc. Further, although for the exemplary embodiment depicted, the torsional response is provided by the electric machines 204, 205, in other exemplary embodiments, the torsional response from the electric machines may be in combination with other actions, such as modification of one or more variable geometry components (e.g., variable guide vanes), fuel flow, etc.

Referring now to FIG. 5, a control logic diagram 500 that may be used by the controller 210 for operating a hybrid-electric propulsion system of an aircraft is provided. The hybrid-electric propulsion system may be configured in a similar manner as one or more of the exemplary hybrid-electric propulsion systems described above with reference to FIGS. 1 through 4. As shown in in control logic diagram 500, the system may be capable of detecting that a stall has occurred within one of the compressors 202 or 203 through the use of the engine controller 210 (or FADEC as described above). For example, the system may be operable to determine which of the compressors 202 or 203 has entered a stall by determining, with the controller 210, that the pressure or temperature sensed data from the sensors 208 has passed a threshold of a stall condition within one of the LP compressor 202 or the HP compressor (e.g. a rotating stall in some embodiments). As shown in the control logic diagram 500, once the system has determined which of the compressors (either the LP compressor 202 or HP compressor 203) has entered an aerodynamically unstable state (such as a rotating instability, a rotating stall, or a surge stall). the controller 210 may begin transferring power from the aerodynamically stable compressor (the other of the compressor 202 or 203, which was not determined to be an aerodynamically unstable) to the aerodynamically unstable compressor. The power transfer may be done either incrementally or continuously until the system has determined that the stall has been cleared, at which point the engine may resume normal operation.

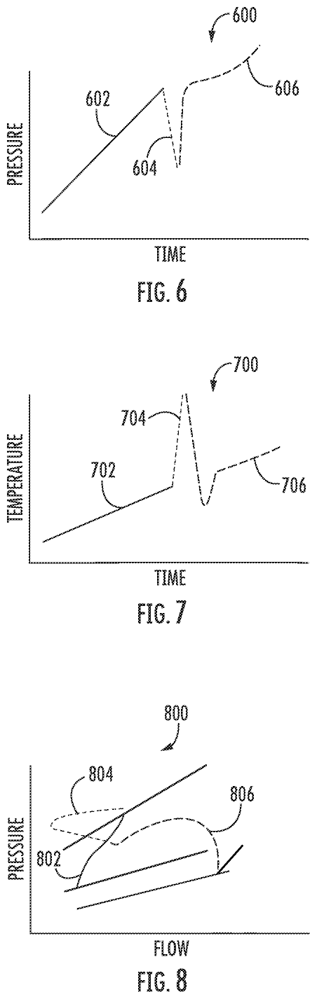

FIGS. 6 through 8 illustrate various graphs of an actively accelerating or decelerating hybrid-electric propulsion system (such as the hybrid-electric propulsion systems described herein with reference to FIGS. 1 through 4), which is equipped with an active compressor recovery system. For example, FIG. 6 illustrates a pressure vs time plot 600 of an actively accelerating or decelerating hybrid-electric propulsion system, on which pressure data from sensors (such as the sensors 208) positioned within a compressor are plotted against time. FIG. 7 illustrates a temperature vs time plot 700 of an actively accelerating or decelerating hybrid-electric propulsion system, on which temperature data from sensors (such as the sensors 208) positioned within a compressor are plotted against time. FIG. 8 illustrates a pressure vs flow plot 800 of an actively accelerating or decelerating hybrid-electric propulsion system, on which pressure data from sensors (such as the sensors 208) positioned within a compressor are plotted against the flow through the core air flowpath of the compressor (such as the core air flowpath 206). As shown in FIGS. 6 through 8, the data from each of the plots includes three segments a solid segment 602, 702, 802, a dashed segment 604, 704, 804, and a dotted segment 606, 706, 806. The solid segments 602, 702, 802 represent data from within the compressor prior to the compressor entering a stall condition or represent normal operating conditions, the dashed line 604, 704, 804 represents data from within the compressor after the compressor has entered a stall condition but before the power transfer has been initiated by the controller 210, and the dotted line 606, 706, 806 represents data from within the compressor once the power transfer from the power converter 212 has been initiated until the compressor has exited the stall condition. As shown by the dashed lines 604 and 704 in FIGS. 6 and 7, a drop in pressure is generally indicative of a stall condition, and a rise in pressure is also indicative of a stall condition. In this way, the controller 210 described herein may advantageously determine that one of the compressors (e.g. the LP compressor 202 or the HP compressor 203) has entered a stall condition based on the sensed pressure and/or temperature data.

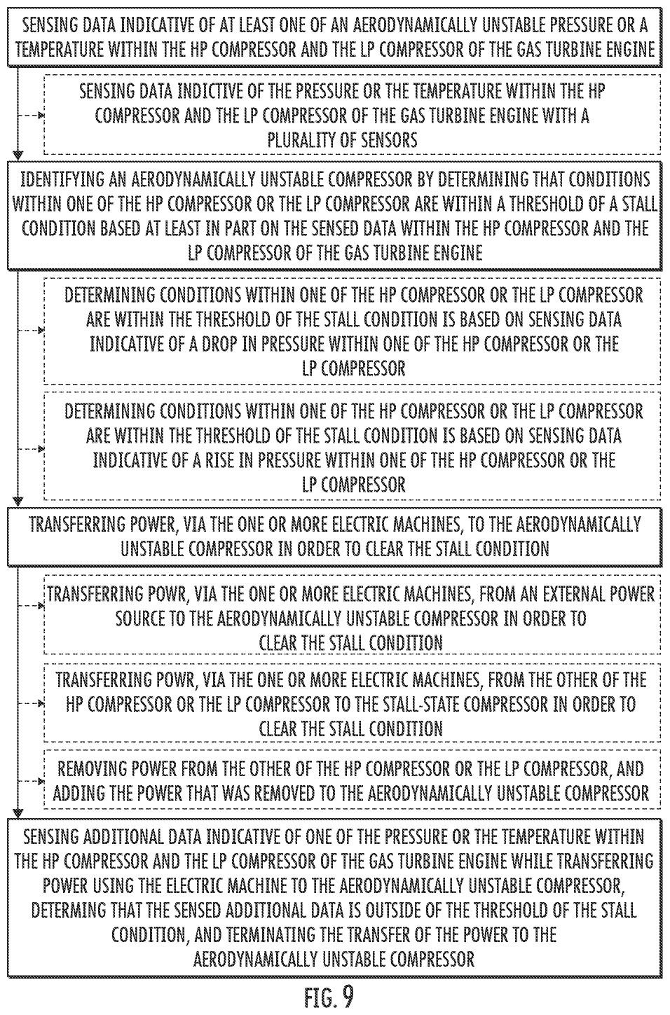

Referring now to FIG. 9, a flow diagram of a method 900 for operating a hybrid-electric propulsion system of an aircraft is provided, in which the dashed boxes indicate optional steps of the method 900. The hybrid-electric propulsion system may be configured in a similar manner as one or more of the exemplary hybrid-electric propulsion systems described above with reference to FIGS. 1 through 4. For example, the hybrid-electric propulsion system may include a gas turbine engine having a HP compressor, an LP compressor, and at least one electric machine coupled to the HP compressor or the LP compressor.

As is depicted, the method 900 generally includes a step 902 of sensing data indicative of at least one of an aerodynamic instability, a pressure, or a temperature within the HP compressor and the LP compressor of the gas turbine engine. For example, the data may be sensed by utilizing one or more of the sensors described herein (such as the sensors 114 or 208). For the exemplary aspect depicted in FIG. 9, the method 900 may optionally include a step 904 of sensing data indicative of one of the pressure or the temperature within the HP compressor or and the LP compressor of the gas turbine engine with a plurality of sensors.

As shown in FIG. 9, the method 900 may further include as step 906 of identifying an aerodynamically unstable compressor by determining that conditions within one of the HP compressor or the LP compressor are within a threshold of a stall condition based at least in part on the sensed data within the HP compressor and the LP compressor of the gas turbine engine. For example, in the step 906, the one of the HP compressor or the LP compressor that is determined to be within the threshold of a stall condition is the aerodynamically unstable compressor. In this way, once the system is able to identify that one of the compressors has entered a stall state, it may begin transferring power thereto to aid the aerodynamically unstable compressor in recovering from the stall condition. In some embodiments, as shown in FIG. 9, the method may further include an optional step 908 of determining conditions within one of the HP compressor or the LP compressor are within the threshold of the stall condition is based on sensing data indicative of a drop in pressure within one of the HP compressor or the LP compressor. Additionally or alternatively, the method 900 may include an optional step 910 of determining conditions within one of the HP compressor or the LP compressor are within the threshold of the stall condition is based on sensing data indicative of a rise in temperature within one of the HP compressor or the LP compressor. For example, as shown on the graphs in FIGS. 6 through 8, a drop in temperature, as sensed by sensors 208, is indicative of a stalling compressor. Similarly, a rise in temperature, as sensed by sensors 208, is also indicative of a stalling compressor.

Referring still to FIG. 9, the method 900 may further include a step 912 of transferring power, via the one or more electric machines, to the aerodynamically unstable compressor in order to clear the stall condition. For example, in some embodiments, the method 900 may include an optional step 914 of transferring power, via the one or more electric machines, from an external power source to the aerodynamically unstable compressor in order to clear the stall condition. In additional or alternative embodiments, the method 900 may include a step 916 of transferring power, via the one or more electric machines, from the other of the HP compressor or the LP compressor to the aerodynamically unstable compressor in order to clear the stall condition. In many embodiment, the step 916 may include a further step 918 of removing power from the other of the HP compressor or the LP compressor, and adding the power that was removed to the aerodynamically unstable compressor.

In some embodiments, the method 900 may further include an optional step 920 of sensing additional data indicative of one of the pressure or the temperature within the HP compressor and the LP compressor of the gas turbine engine while transferring power using the electric machine to the aerodynamically unstable compressor, determining that the sensed additional data is outside of the threshold of the stall condition, and terminating the transfer of power to the aerodynamically unstable compressor.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

Further aspects of the invention are provided by the subject matter of the following clauses:

A method for operating a hybrid-electric propulsion system of an aircraft, the hybrid-electric propulsion system comprising a gas turbine engine having a high pressure (“HP”) compressor, a low pressure (“LP”) compressor, and one or more electric machines coupled to at least one of the HP compressor and the low pressure compressor, the method comprising: sensing data indicative of at least one of an aerodynamic instability, a pressure, or a temperature within the HP compressor and the LP compressor of the gas turbine engine; identifying an aerodynamically unstable compressor by determining that conditions within one of the HP compressor or the LP compressor are within a threshold of a stall condition based at least in part on the sensed data within the HP compressor and the LP compressor of the gas turbine engine, the one of the HP compressor or the LP compressor that is determined to be within the threshold of a stall condition being the aerodynamically unstable compressor; and transferring power, via the one or more electric machines, to the aerodynamically unstable compressor in order to clear the stall condition.

The method of one or more of these clauses, wherein the transferring step further comprises:

transferring power, via the one or more electric machines, from an external power source to the aerodynamically unstable compressor in order to clear the stall condition.

The method of one or more of these clauses, wherein the transferring step further comprises: transferring power, via the one or more electric machines, from the other of the HP compressor or the LP compressor to the aerodynamically unstable compressor in order to clear the stall condition.

The method of one or more of these clauses, wherein transferring power from the other of the HP compressor or the LP compressor to aerodynamically unstable compressor comprises: removing power from the other of the HP compressor or the LP compressor; and adding the power that was removed to the aerodynamically unstable compressor.

The method of one or more of these clauses, wherein the power is transferred continuously at a set rate to the aerodynamically unstable compressor while repeating the sensing step and the determining step until the stall condition is cleared.

The method of one or more of these clauses, wherein the power is transferred incrementally at a set interval of time to the aerodynamically unstable compressor while repeating the sensing step and the determining step until the stall condition is cleared.

The method of one or more of these clauses, wherein the power is transferred to the aerodynamically unstable compressor in increments of between about 50 horsepower and about 150 horsepower.

The method of one or more of these clauses, wherein the stall condition is cleared and the transfer of power is terminated once the conditions within the aerodynamically unstable compressor are outside the threshold of the stall condition based at least in part on the sensed data within the HP compressor and the LP compressor of the gas turbine engine.

The method of one or more of these clauses, further comprising accelerating or decelerating the gas turbine engine while performing the sensing step, the identifying step, and the transferring step.

The method of one or more of these clauses, wherein determining conditions within one of the HP compressor or the LP compressor are within the threshold of the stall condition is based on sensing data indicative of a drop in pressure within one of the HP compressor or the LP compressor.

The method of one or more of these clauses, wherein determining conditions within one of the HP compressor or the LP compressor are within the threshold of the stall condition is based on sensing data indicative of a rise in temperature within one of the HP compressor or the LP compressor.

The method of one or more of these clauses, further comprising: sensing additional data indicative of one of the pressure or the temperature within the HP compressor and the LP compressor of the gas turbine engine while transferring power using the electric machine to the aerodynamically unstable compressor; determining that the sensed additional data is outside of the threshold of the stall condition; and terminating the transfer of power to the aerodynamically unstable compressor.

The method of one or more of these clauses, wherein sensing data indicative of one of the pressure or the temperature within the HP compressor and the LP compressor of the gas turbine engine comprises sensing data indicative of one of the pressure or the temperature within the HP compressor and the LP compressor of the gas turbine engine with a plurality of sensors.

The method of one or more of these clauses, wherein the plurality of sensors are arranged along an axial direction of the engine.

The method of one or more of these clauses, wherein the plurality of sensors are arranged along a circumferential direction of the engine.

A hybrid-electric propulsion system of an aircraft, the hybrid-electric propulsion system comprising: a gas turbine engine having a high pressure (“HP”) compressor, a low pressure (“LP”) compressor, at least one electric machine coupled to at least one of the HP compressor and the LP compressor, and a controller, the controller including memory and one or more processors, the memory storing instructions that when executed by the one or more processors cause the system to perform the following: sense data indicative of at least one of an aerodynamic instability, a pressure, or a temperature within the HP compressor and the LP compressor of the gas turbine engine; identify an aerodynamically unstable compressor by determining that conditions within one of the HP compressor or the LP compressor are within a threshold of a stall condition based at least in part on the sensed data within the HP compressor and the LP compressor of the gas turbine engine, the one of the HP compressor or the LP compressor that is determined to be within the threshold of a stall condition being the aerodynamically unstable compressor; and transfer power, via the one or more electric machines, to the aerodynamically unstable compressor in order to clear the stall condition.

The system of one or more of these clauses, wherein the transferring step further comprises: transferring power, via the one or more electric machines, from an external power source to the aerodynamically unstable compressor in order to clear the stall condition.

The system of one or more of these clauses, wherein the transferring step further comprises: transferring power, via the one or more electric machines, from the other of the HP compressor or the LP compressor to the aerodynamically unstable compressor in order to clear the stall condition.

The system of one or more of these clauses, wherein transferring power from the other of the HP compressor or the LP compressor to aerodynamically unstable compressor comprises: removing power from the other of the HP compressor or the LP compressor; and adding the power that was removed to the aerodynamically unstable compressor.

The system of one or more of these clauses, wherein the power is transferred continuously at a set rate to the aerodynamically unstable compressor while repeating the sensing step and the determining step until the stall condition is cleared.

What is claimed is:

1. A method for operating a hybrid-electric propulsion system of an aircraft, the hybrid-electric propulsion system comprising a gas turbine engine having a high pressure (“HP”) compressor, a low pressure (“LP”) compressor, and one or more electric machines coupled to at least one of the HP compressor and the low pressure compressor, the method comprising:
sensing data indicative of at least one of an aerodynamic instability of the engine, a pressure, or a temperature within the HP compressor and the LP compressor of the gas turbine engine;
identifying an aerodynamically unstable compressor by determining that conditions within one of the HP compressor or the LP compressor are within a threshold of a stall condition based at least in part on the sensed data, the one of the HP compressor or the LP compressor that is determined to be within the threshold of a stall condition being the aerodynamically unstable compressor; and
transferring power, via the one or more electric machines, to the aerodynamically unstable compressor in order to prevent or clear the stall condition.

2. The method of claim 1, wherein the transferring step further comprises:
transferring power, via the one or more electric machines, from an external power source to the aerodynamically unstable compressor.

3. The method of claim 1, wherein the transferring step further comprises:
transferring power, via the one or more electric machines, from the other of the HP compressor or the LP compressor to the aerodynamically unstable compressor.

4. The method of claim 3, wherein transferring power from the other of the HP compressor or the LP compressor to aerodynamically unstable compressor comprises:
removing power from the other of the HP compressor or the LP compressor; and
adding the power that was removed to the aerodynamically unstable compressor.

5. The method of claim 1, wherein the power is transferred continuously at a set rate to the aerodynamically unstable compressor while repeating the sensing step and the determining step until the stall condition is cleared.

6. The method of claim 1, wherein the power is transferred incrementally at a set interval of time to the aerodynamically unstable compressor while repeating the sensing step and the determining step until the stall condition is cleared.

7. The method of claim 6, wherein the power is transferred to the aerodynamically unstable compressor in increments of between about 50 horsepower and about 150 horsepower.

8. The method of claim 5, wherein the stall condition is cleared and the transfer of power is terminated once the conditions within the aerodynamically unstable compressor are outside the threshold of the stall condition based at least in part on the sensed data within the HP compressor and the LP compressor of the gas turbine engine.

9. The method of claim 1, further comprising accelerating or decelerating the gas turbine engine while performing the sensing step, the identifying step, and the transferring step.

10. The method of claim 1, wherein determining conditions within one of the HP compressor or the LP compressor are within the threshold of the stall condition is based on sensing data indicative of a drop in pressure within one of the HP compressor or the LP compressor.

11. The method of claim 1, wherein determining conditions within one of the HP compressor or the LP compressor are within the threshold of the stall condition is based on sensing data indicative of a rise in temperature within one of the HP compressor or the LP compressor.

12. The method of claim 1, further comprising
sensing additional data indicative of one of the pressure or the temperature within the HP compressor and the LP compressor of the gas turbine engine while transferring power using the electric machine to the aerodynamically unstable compressor;
determining that the sensed additional data is outside of the threshold of the stall condition; and
terminating the transfer of power to the aerodynamically unstable compressor.

13. The method of claim 1, wherein sensing data indicative of one of the pressure or the temperature within the HP compressor and the LP compressor of the gas turbine engine comprises sensing data indicative of one of the pressure or the temperature within the HP compressor and the LP compressor of the gas turbine engine with a plurality of sensors.

14. The method of claim 13, wherein the plurality of sensors are arranged along an axial direction of the engine.

15. The method of claim 13, wherein the plurality of sensors are arranged along a circumferential direction of the engine.

16. A hybrid-electric propulsion system of an aircraft, comprising:
a gas turbine engine having a high pressure (“HP”) compressor, a low pressure (“LP”) compressor, at least one electric machine coupled to at least one of the HP compressor and the LP compressor, and a controller, the controller including memory and one or more processors, the memory storing instructions that when executed by the one or more processors cause the system to perform the following:
sense data indicative of at least one of an aerodynamic instability, a pressure, or a temperature within the HP compressor and the LP compressor of the gas turbine engine;
identify an aerodynamically unstable compressor by determining that conditions within one of the HP compressor or the LP compressor are within a threshold of a stall condition based at least in part on the sensed data, the one of the HP compressor or the LP compressor that is determined to be within the threshold of a stall condition being the aerodynamically unstable compressor; and
transfer power, via the one or more electric machines, to the aerodynamically unstable compressor in order to prevent or clear the stall condition.

17. The system of claim 16, wherein the transferring step further comprises:
transferring power, via the one or more electric machines, from an external power source to the aerodynamically unstable compressor.

18. The system of claim 16, wherein the transferring step further comprises:
transferring power, via the one or more electric machines, from the other of the HP compressor or the LP compressor to the aerodynamically unstable compressor.

19. The system of claim 16, wherein transferring power from the other of the HP compressor or the LP compressor to aerodynamically unstable compressor comprises:
removing power from the other of the HP compressor or the LP compressor; and
adding the power that was removed to the aerodynamically unstable compressor.

20. The system of claim 16, wherein the power is transferred continuously at a set rate to the aerodynamically unstable compressor while repeating the sensing step and the determining step until the stall condition is cleared.
